(19) United States
(12) Patent Application Publication
(10) Pub. No.: US 2013/0080145 A1
(43) Pub. Date: Mar. 28, 2013

(54) NATURAL LANGUAGE PROCESSING APPARATUS, NATURAL LANGUAGE PROCESSING METHOD AND COMPUTER PROGRAM PRODUCT FOR NATURAL LANGUAGE PROCESSING

(71) Applicants: Tomohiro Yamasaki, Tokyo (JP); Masaru Suzuki, Kanagawa-ken (JP)

(72) Inventors: Tomohiro Yamasaki, Tokyo (JP); Masaru Suzuki, Kanagawa-ken (JP)

(73) Assignee: KABUSHIKI KAISHA TOSHIBA, Tokyo (JP)

(21) Appl. No.: 13/535,820

(22) Filed: Jun. 28, 2012

(30) Foreign Application Priority Data
Sep. 22, 2011 (JP) 2011-207823

(51) Int. Cl. G06F 17/28

(52) U.S. Cl. 704/2

(57) ABSTRACT

According to one embodiment, a natural language processing apparatus includes a translation storage unit which stores (a) a plurality of translation documents having an unknown language document and one or more known language documents, and (b) domains of the translation documents; a translation search unit which specifies one of the domains and search the translation storage unit for the translation documents; a word extraction unit which extracts a pair of words corresponding an unknown language word to a known language word, from the translation documents; an answer creation unit which estimates an analysis result of the unknown language document in the translation documents based on the pair of words and an analysis result of the known language document in the translation documents; and an analyzer creation unit which creates an analyzer of the unknown language document based on the analysis result of the unknown language document.

### CROSS REFERENCE TO RELATED APPLICATION

This application is based upon and claims the benefit of priority from Japanese Patent Application No. 2011-207823, filed on Sep. 22, 2011; the entire contents of which are incorporated herein by reference.

### FIELD

Embodiments described herein relate generally to natural language processing apparatuses and associated methods.

### BACKGROUND

In recent years, the statistical technique is widely used as a method of creating the analyzer which processes word class analysis, syntax analysis, etc. In the statistical technique, the analyzer learns analysis results given by human resources as supervisor data.

However, it is difficult for us to give analysis results to a language which we hardly know and an analyzer we have can not analyze (hereinafter referred to as “unknown language”).

Therefore, one conventional technique is to collect the translation documents of an unknown language and a language which an analyzer can analyze (hereinafter referred to as “known language”), and to estimate an analysis result of the unknown language document by using an analysis results of the known language document. In the conventional technique, the analyzer learns the estimated analysis results of the unknown language document as supervisor data.

However, in the conventional technique, the analyzer is not created in consideration of a domain of the collected translation documents. When a domain of a document to be analyzed differs from a domain of the created analyzer, there is a problem that the accuracy of the analyzer decreases.

For example, when the first domain of translation documents by which the analyzer was created is “sports”, and on the other hand, the second domain of a document to be analyzed is “politics”, the second domain differs from the first domain. The conventional technique thereby decreases the accuracy of the analysis results in the first domain.

### BRIEF DESCRIPTION OF THE DRAWINGS

FIG. 1 shows a natural language processing apparatus of one embodiment.

FIG. 2 shows the hardware construction of the natural language processing apparatus.

FIG. 3 shows examples of collecting sources of translation documents according to the embodiment.

FIG. 4 shows examples of the translation documents.

FIGS. 5A and 5B show examples of degrees of similarity.

FIGS. 6A and 6B show examples of pairs of words.

FIG. 7 shows examples of analysis results of documents in an unknown language.

FIG. 8 illustrates a flow chart of the natural language processing apparatus.

FIG. 9 illustrates a flow chart of the translation search unit.

FIG. 10 illustrates a flow chart of extracting proper nouns.

FIG. 11 illustrates a flow chart of extracting collocations.

FIG. 12 illustrates a flow chart of extracting pairs of words.

FIG. 13 shows cross-tabulation tables.

FIG. 14 illustrates a flow chart of estimating word inflexions.

FIG. 15 shows examples of pairs of words.

FIG. 16 shows priorities of the grammar matters in a word.

FIG. 17 shows priorities of the grammar matters in a sentence.

### DETAILED DESCRIPTION

According to one embodiment, a natural language processing apparatus includes a translation storage unit configured to store (a) a plurality of translation documents having an unknown language document and one or more known language documents, and (b) domains of the translation documents; a translation search unit configured to specify one of the domains and search the translation storage unit for the translation documents; a word extraction unit configured to extract a pair of words corresponding an unknown language word to a known language word, from the translation documents; an answer creation unit configured to estimate an analysis result of the unknown language document in the translation documents based on the pair of words and an analysis result of the known language document in the translation documents; and an analyzer creation unit configured to create an analyzer of the unknown language document based on the analysis result of the unknown language document.

Various Embodiments will be described hereinafter with reference to the accompanying drawings.

(One Embodiment)

A natural language processing apparatus of one embodiment is an apparatus providing an analyzer for unknown language by using translation documents of the unknown language and a known language. The unknown language represents a language which an analyzer can not analyze by using word class analysis and syntax analysis. The known language represents a language which the analyzer can analyze.

The analyzer provided by the apparatus can analyze another unknown language. If documents written by unknown languages of all the world can be analyzed, one advantageous result is the expansion around all the world of analysis services for estimating interests and purposes of user documents and analyzing reputations and complaints for products.

Initially, an unknown language and a domain are designated. The apparatus searches translation documents adapted by the unknown language and the domain and creates an analyzer for the unknown language by using the translation documents.

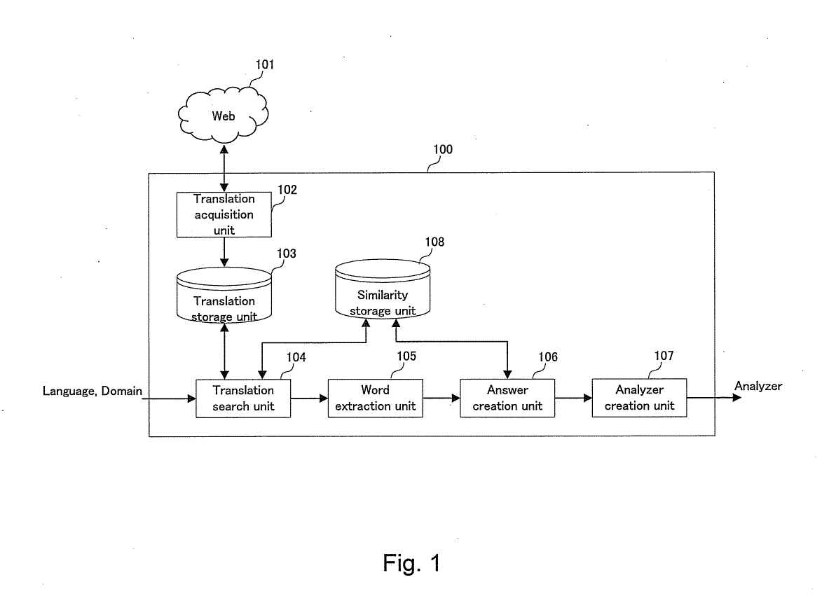

FIG. 1 shows the entire apparatus 100. The apparatus 100 includes a translation acquisition unit 102 acquiring translation documents of an unknown language and one or more known languages from contents in Web 101, a translation storage unit 103 storing the translation documents and corresponding domain of the translation documents, a translation search unit 104 designating a unknown language and a domain and searching translation documents from the unit 103, a word extraction unit 105 extracting a pair of words having word of the unknown language and corresponding word of the known language from the translation documents searched by the unit 104, an answer creation unit 106 estimating an analysis result of the unknown language document in the translation documents searched by the unit 104 based on the pair of words and an analysis result of the known language document in the translation documents, and an answer creation unit 107 creating an analyzer of the unknown language based on the analysis result of the unknown language document.

The unit 104 searches the translation documents by using degree of similarity between the domains (hereinafter referred to as “first degree of similarity”) or degree of similarity between the languages (hereinafter referred to as “second degree of similarity”). Definitions for the first degree of similarity and the second degree of similarity are mentioned later. The domains and the languages are stored by the unit 108. In a similar way, the unit 106 estimates an analysis result of the unknown language document by using the first degree or the second degree of similarity.

(Hardware Construction)

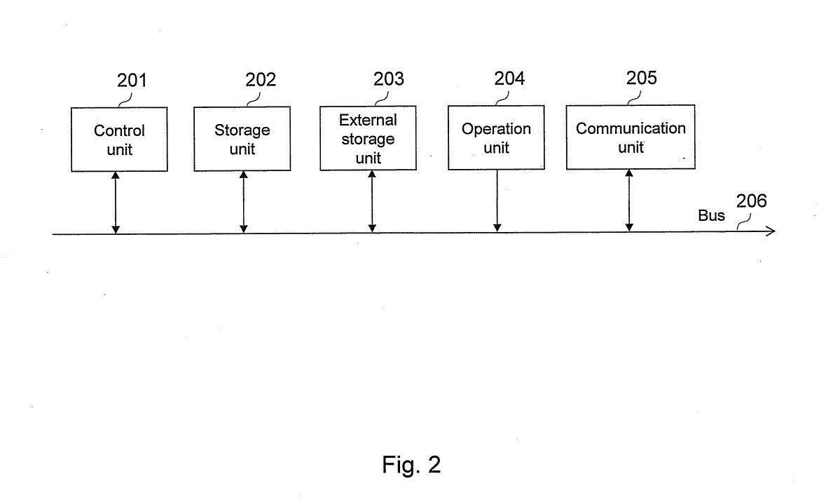

FIG. 2 shows the hardware construction of the apparatus 100. The apparatus 100 includes a control unit 201 being CPU (Central Processing Unit), etc. controlling the entire apparatus 100, a storage unit 202 being ROM (Read Only Memory), RAM (Random Access Memory), etc. storing various data and various programs, a non-transitory external storage unit 203 being HDD (Hard Disk Drive), CD (Compact Disk) drive, etc. storing various data and various programs, an operation unit 204 being a keyboard, a mouse, etc. receiving operations inputted by a user, a communication unit 205 controlling the communication to an external device, and the bus 206 connecting the units 201-205.

In the hardware construction, the unit 201 executes the various programs stored by the unit 202 and the unit 203 to do the following functions.

(Translation Acquisition Unit)

The unit 102 acquires the translation acquires the translation documents of the unknown language and the known language. If the known language is only one language, the unit 102 may not acquire the sufficient translation documents. So the known language had better be a plurality of the known languages. For example, in the case of an Eastern European language, it often happens that the first translation documents between the Eastern European language and Russian language are more similar than the second translation documents between the Eastern European language and English language. So if the unknown language is Eastern European language, the unit 102 had better acquire not only the second translation documents but also the first translation documents.

The unit 102 acquires contents in Web 101 accessible through the unit 205 as collecting source of the translation documents. For example, the collecting source of the translation documents are the documents delivered at regular intervals that are news articles sourced by major news sites, the multiple languages closed caption data sourced by TV broadcasts, and the DVD multiple languages closed caption data and the bestselling novels translated to the languages of all the countries of the world. In case of DVD multiple languages closed caption data and the bestselling novels, the unit 102 acquires them each time published. In case of News articles and TV broadcasts multiple languages closed caption data, the unit 102 preliminarily determines the individual acquisition intervals each collecting sources, because the delivering intervals differ each collecting sources.

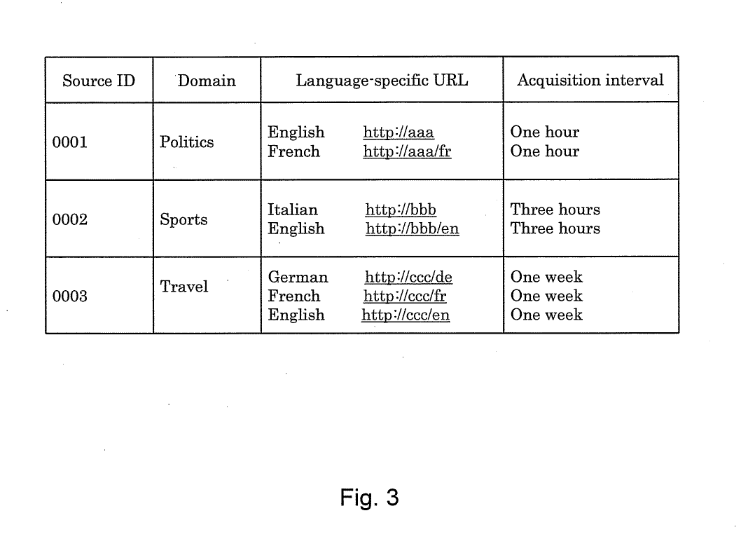

FIG. 3 shows examples of URL and acquisition interval each Source ID, domain and language of translation documents. Domains are keywords that represent fields, category, etc. of the translation documents. Source ID 0001 represents that the news articles according to politics are acquired from URL http://aaa for English articles and URL http://aaa/fr for French articles each one hour.

If the known language is just one language, similar processes are executed in the following units.

(Translation Storage Unit)

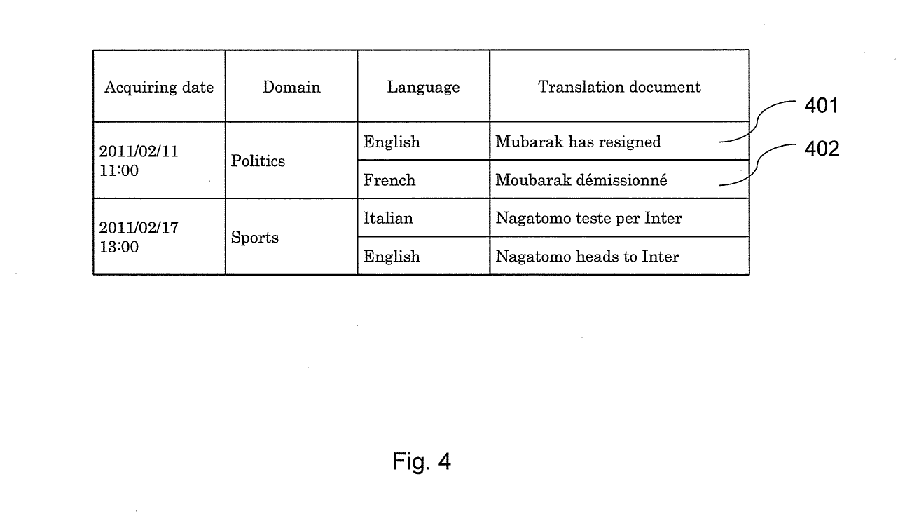

The unit 103 stores the translation documents and their domains acquired by the unit 102 in the unit 202 or the unit 203. FIG. 4 shows examples of the translation documents stored by the unit 103. FIG. 4 shows the documents according to politics acquired at 11:00 on 2011 Feb. 11 are the translation documents of the English documents 401 and the French documents 402.

(Similarity Storage Unit)

The unit 108 stores the first degree of similarity or the second degree of similarity it the unit 202 or the unit 203. The first degree of similarity is set by summarizing categories of known news sites or using distance between words of Semantic web, for example WordNet. The second degree of similarity is set based on knowledge of comparative linguistics or quantitative linguistics.

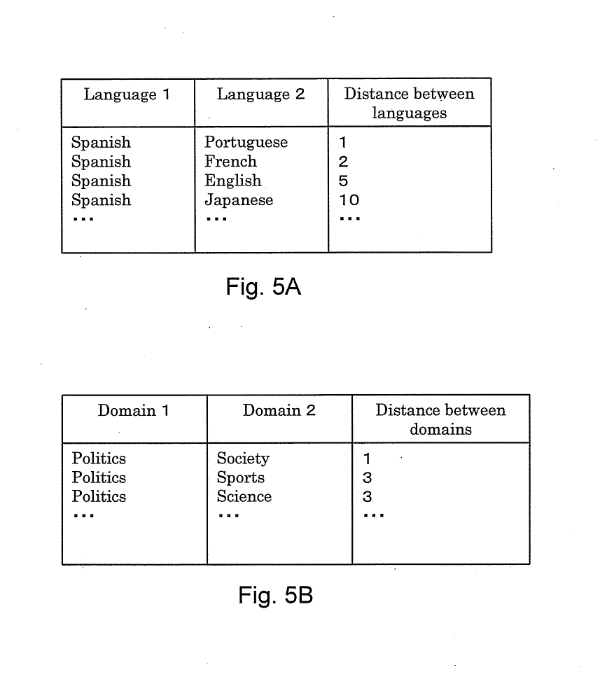

FIGS. 5A and 5B show examples of the first and the second degrees of similarity stored in the unit 208. These figures represents that the shorter of the distance is the more similar of the degree of similarity. For example, FIG. 5A shows that Spanish is more similar of the first degree of similarity with Portuguese and French than the first degree of similarity with Japanese.

(Translation Search Unit)

The unit 104 designates combination of the unknown language and the domain (Unknown language=LO, Domain=D0) and search translation documents from the unit 103. User can designate the unknown language and the domain by the unit 204. Or unknown languages and domains of documents can be designated by a domain estimate module (un-illustrating) estimating the domains or language estimate module (un-illustrating) estimating the unknown languages. The language estimate module can estimate languages by using tables of appearance frequency about characters or words. The domain estimate module can estimate domain by using the tables of appearance frequency about words of the language estimated by the language estimate module and ratio of grammars (for example, indicative mood and subjunctive mood) about the words.

(Word Extraction Unit)

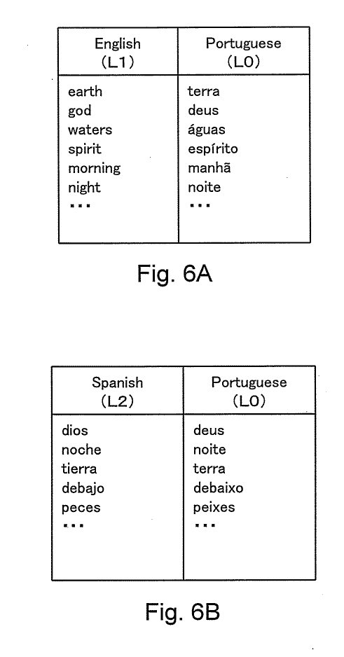

The unit 105 extracts a pair of words having word of the unknown language and corresponding word of the known language from the translation documents searched by the unit 104. The unit 105 extracts a word pair of L0 and L1, a word pair of L0 and L2, etc. by using each translation document about combination of unknown language=L0, domain=D0 and known language=L1, domain=D1, combination of L0, D0 and L2, D2, etc. FIGS. 6A and 6B show examples of pairs of words extracted by the unit 105. FIG. 6A shows pairs of words about unknown language (L0)=Portuguese, known language (L1)=English. FIG. 6B shows pairs of words about unknown language (L0)=Portuguese, known language (L2)=Spanish.

For extracting pairs of words, the unit 105 extracts proper noun, collocation and notational similar word and estimates word inflexion and a word of known language corresponding to a word of unknown language by using statistical information between languages.

(Answer Creation Unit)

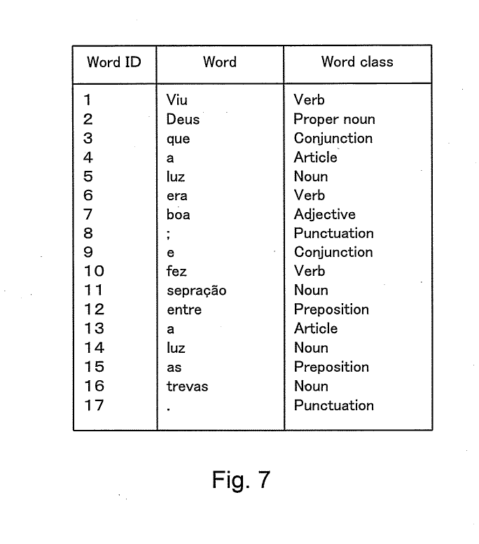

The unit 106 estimates the unknown language document of the searched translation documents by using the pairs of words and the analysis results of the known language document of the searched translation documents. FIG. 7 shows examples of analysis results of documents in Portuguese.

(Analyzer Creation Unit)

The unit 107 executes machine learning about analysis results of documents in unknown language L0 estimated by the unit 106 as supervisor data. Machine learning can be used by CRF (Conditional Random Fields). CRF divides the analysis results into sentences and executes machine learning about analyzer based on surfaces and classes of words before and after as those features.

(Flow Chart)

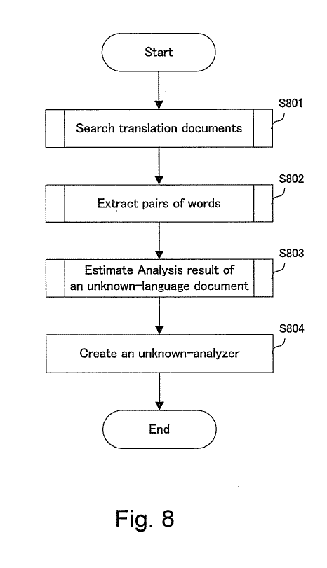

FIG. 8 illustrates a flow chart of the apparatus 100.

(Step S801)

In S801, the unit 104 designates combination of unknown language and domain (L0, D0) searches the translation documents from the unit 103. Specifically the unit 104 searches combination L0, a language near L0, D0 and a domain near D0 from the translation documents stored in the unit 103.

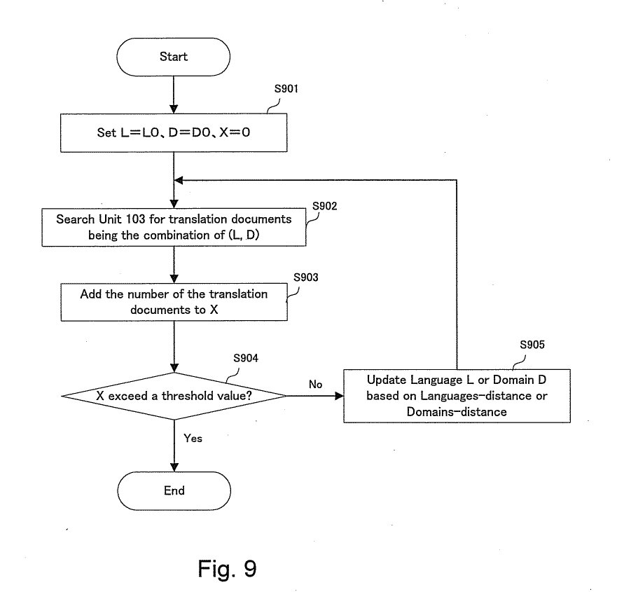

FIG. 9 illustrates a flow chart of the unit 104. In S901, L=L0, D=D0 and X=0 are set. X is a parameter that represents the numbers of the searched translation documents. The more numbers of the translation documents are searched, the more numbers of supervisor data is used in machine learning and the higher accuracy of the analyzer.

The translation documents being the combination of (L, D) is searched from the unit 103 (S902). The number of the translation documents is added to X (S903). Whether X exceeds a threshold value is determined and if X exceeds the threshold value, the process is ended (S904). If X does not exceed the threshold value, the process is moved to S905. Another combination of language and domain being the nearest to (L0, D0) is updated based on distance between the languages and distance between the domains stored in the unit 108 (S905). The translation documents are searched based on the updated combination (L, D) (S902).

In general, ten thousand documents are required to execute machine learning about high-accurate analyzer. So, for example, X is set to ten thousand in this embodiment.

In S905, the combination of language and domain can be updated based on compatibility of language and domain. For example, if Domain D0 is medical service, language L is set to German. If Domain D0 is fashion, language L is set to French or Italian. If Domain D0 is IT (Information Technology), language L is set to English.

If X does not exceed the threshold value by updating language and domain in S905, the unit 102 can acquire the new translation documents corresponding to the combination of (L0, D0).

The apparatus 100 searches the translation documents adapted by the designated language and domain and can create analyzer.

(Step S802)

In S802, the unit 105 extracts pairs of words corresponding to unknown language words and known language words from the translation documents searched by the unit 104. The following describes the method of extracting pairs of words from the translation documents of (L0, D0) and (L1, D1).

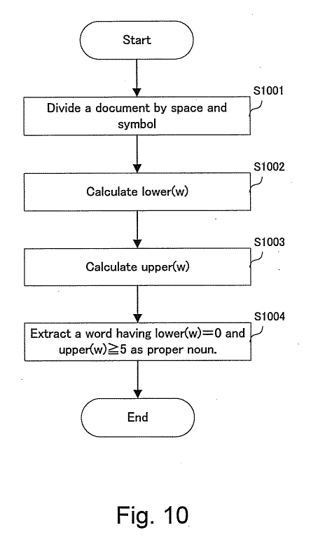

Proper nouns and collocations of the unknown language L0 are extracted based on statistical information of the unknown language L0. FIG. 10 illustrates a flow chart of extracting proper nouns. For example, in case of European languages, words which always start with a capital letter are more likely to be proper nouns. In S1001, the translation documents are divided by spaces and symbols to get word “w”. Lower (w) and Upper (w) are calculated about word “w” (S1002, S1003). Lower (w) represents appearance number in case word “w” is all small letters. Upper (w) represents appearance number in case word “w” starts with a capital letter or is all capital letters.

In S1004, word “w” having lower (w)=0 and upper(w)≧5 is extracted as a proper noun. Probability that a word except a proper noun fulfills the conditions is less than or equal to (½)⁵= 1/32. So we can conclude word “w” is a proper noun at the 5% significance level.

Languages which distinguish proper nouns and common nouns in writing, can be processed in similar way although they are not European languages. Japanese Language, which is difficult to extract proper nouns, can be extracted in all KATAKANA words as proper nouns.

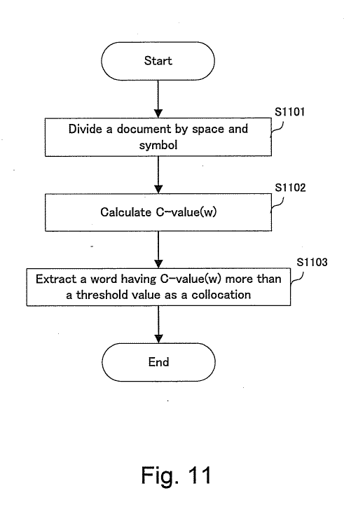

FIG. 11 illustrates a flow chart of extracting collocations. Collocations are extracted by using C-value in this embodiment. First, the translation documents are divided by spaces and symbols to get word “w” (S1101). Next, C-value (w) is calculated (S1102). Finally, words in which C-value (w) exceeds the threshold are extracted as collocation (S1103). The threshold value is depended on frequency of the all words. So the threshold value is set to “0” because of simplicity in this embodiment.

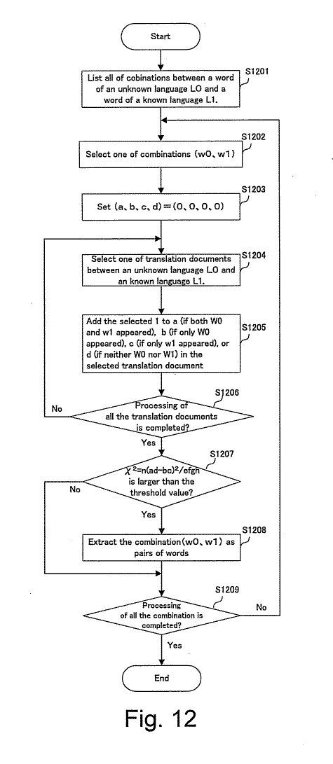

FIG. 12 illustrates a flow chart of extracting pairs of words. There are n sets of the translation documents of (L0, D0) and (L1, D1).

All combinations between words of the unknown language L0 and words of the known language L1 are listed (S1201). The words each language is extracted by dividing by spaces and symbols.

One of combinations (w0, w1) is selected from combinations of all words as the candidate for processing (S1202). Each parameter “a”, “b”, “c” and “d” is initialized to “0” (S1203). One of the translation documents is selected (S1204).

The parameters are updated based on appearance relation of words “w0” and “w1” in the selected translation documents (S1205). In particular, if both “w0” and “w1” appear, 1 (one) is added to “a”. If both “w0” only appear, 1 (one) is added to “b”. If both “w1” only appear, 1 (one) is added to “c”. if neither “w0” nor “w1” appear, 1 (one) is added to “d”.

It is checked whether Step S1205 is finished in all the translation documents (S1206). In case of not finishing, the process moves to Step S1204 and succeeds for other translation documents. In case of finishing, the process moves to Step S1207 and calculates formula (1).

$${χ}^{2} = \frac{{n ( ad - bc )}^{2}}{efgh} \qquad ( 1 )$$

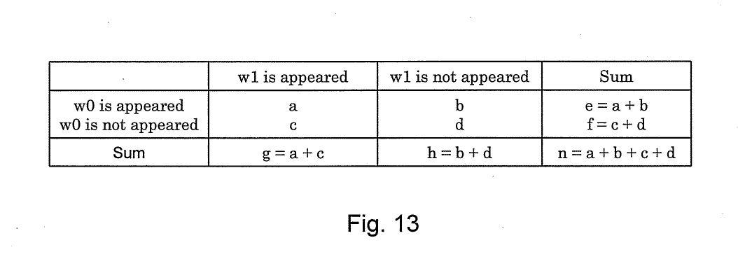

FIG. 13 shows the relations of each parameter in formula (1). The relationship between words can be verified by calculating x² value on cross-tabulation tables in FIG. 13.

Step S1207 compares x² value with the threshold value. If x² value is less than or equal to the threshold value, the process moves to Step S1209. If x² value is more than the threshold value, the process moves to Step S1208. In general, x² value depends on x² distribution. If the relationship is verified at the 5% significance level, the threshold value is set to 3.84.

Step S1208 extracts the combination of (w0, w1) in which x² value is more than the threshold value as pairs of words.

Step S1209 determines whether processing of all the combinations is completed. In case of the processing is not completed, the process moves to Step S1202 and the process succeeds on other combination between words.

The above process uses the appearance relation on the translation documents and can not only extract the correspondence relation of the words but also the correspondence relation of the collocations.

The following describes the process of estimating word inflexions of the unknown language L0 by using standard form information of the known language L1 and the notational similar word of the unknown language L0. The process can extract pairs of words under the word inflections.

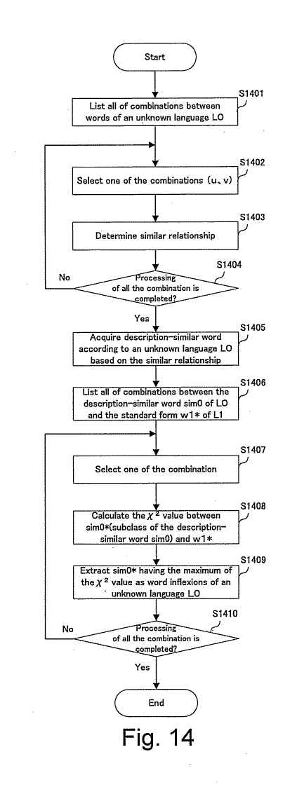

FIG. 14 illustrates a flow chart of estimating word inflexions. Almost languages change forms of words to express grammatical function, although Chinese and Vietnamese do not change the forms of words.

Step S1401 lists all combinations between words of the unknown language L0. Words are extracted by dividing the unknown language documents by spaces and symbols. Step S1402 selects one combination (u, v) from all the combinations.

Step S1403 determines the similar relationship between “u” and “v”. If the length of a common partial sequence is more than or equal to a certain value, it is determined that each word is similar. In particular, if the length of the longer of “u” and “v” is “M”, the length of the shorter of “u” and “v” is “N”, N≧M/2 and common (u [symbol] v)≧M/2, “u” and “v” is similar. Common (u, v) is a function of extracting the length of the interval in which character string of “u” and “v” is common.

Step S1404 determines whether processing of all the combination is completed. In case processing is not completed, the process moves to Step S1402 and the process succeeds on other combination between words. In case of completion, the process moves to Step S1405.

Step S1405 collects all combinations of words which are determined to be similar in S1403 and collects notational similar words of the unknown language L0.

Step S1406 lists all combinations of notational similar words “sim0” of the unknown language L0 and standard form “w1*” of the known language L1. The known language has an analyzer. A set of the word corresponding to the standard form “w1*” can be calculated by executing the analyzer on all words “w” of the known language L1.

Step S1407 selects one of the combinations. Step S1408 calculates x² value with “w1*” about subclass “sim0*ε2̂sim0” of notational similar words “sim0”. Calculation of x² value uses the same processing of the flow chart in FIG. 12. Step S1407 calculates x² value about all subclasses “sim0*”. Step S1409 extracts “sim0*” in which x² value is the maximum as word inflexions of the word corresponding to “w1*”.

The unit 105 can extract pairs of words by executing the above process about not only (L0, D0), (L1, D1) but also other of all the translation documents.

(Step S803)

In S803, the unit 106 estimates an analysis result of the unknown language document in the translation documents searched by the unit 104 based on the pair of words and an analysis result of the known language document in the searched translation documents.

We have an analyzer for the known language. The analysis results of word class can be acquired by executing the analyzer about the known language document. The unit 106 puts the analysis results of the known language words as the analysis results of the unknown language words corresponding to the pairs of words.

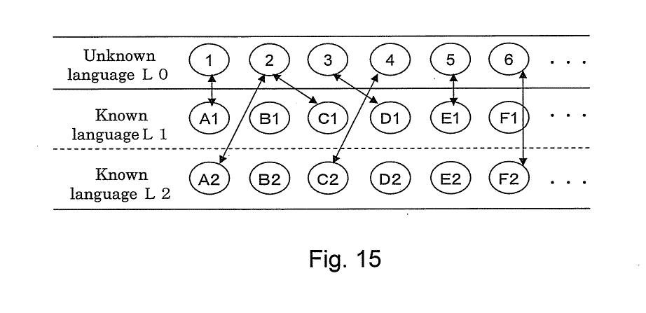

FIG. 15 shows examples of pairs of words extracted by the unit 105. This figure shows pairs of words between the unknown language L0 and the known language L1 and pairs of words between the unknown language L0 and the known language L2. Circles in this figure represent words of each language. Statements in the circles represent IDs of the words. Words connected with the arrows represent pairs of words extracted by the unit 105.

In general, all words of the translation documents do not necessarily have correspondence relationships. Correspondence between the unknown language L0 and the known language L1 can not extract pairs of words about all the words. The conventional method has to estimate the correspondence based on before and after the word that can not be corresponding. There is a problem that an accuracy of estimating the analysis result of the unknown language falls, even if an accuracy of the analysis result of the known language is higher. The apparatus 100 determines final pairs of words, by using not only the corresponding of the unknown language L0 and the known language L1 but also corresponding of the unknown language L0 and the known language L2.

In case of FIG. 15, words 4 and 6 of the unknown language L0 are not corresponding to words of the known language L1, and are corresponding to words C2 and F2 of the known language L2. The apparatus 100 executes corresponding to the unknown language by using the corresponding to a plurality of the known languages. So the accuracy of the pairs of words that is corresponding to the unknown language in this embodiment is higher than that of the conventional method.

There is a case that correspondence to words of known language is plural and an analysis result of a plurality of words is different in case of words of the known language. In such a competition case, the correspondence can be selected under the preliminarily set condition.

In case of FIG. 15, word 2 of the unknown language L0 is not only corresponding to word C1 of the known language L1 but also word A2 of the known language L2. If word C1 is noun and word A2 is adjective, an analysis results of word corresponding to word 2 of the unknown language L0 are competitive. In such case, the unit 106 can adopt the analysis result of shorter distance between languages. The analysis result of words of more similar (shorter distance) languages can be adopted as the analysis result of word 2 by using the distance of words between the unknown language L0 and the known language L1 stored in the unit 108.

The analysis of shorter distance of not only languages but also domains can be adopted. The distance of languages and domains can be used by them in FIG. 5. The distance of languages and domains can be set as different distance for resolving the competition.

Furthermore, the method of resolving competition based on linguistic feature can be adopted. Categories of grammar in linguistic include moods (indicative mood, splicing mood, imperative mood, conditional mood, etc.), voices (active voice, passive voice, etc.) and tenses (present tense, past tense, future tense). In categories of grammar, it can be preliminarily set which languages of the analysis results are adopted. The apparatus 100 can adopt the languages that have detailed categories of grammar, because some languages do not have some moods, some voices, some tenses, etc.

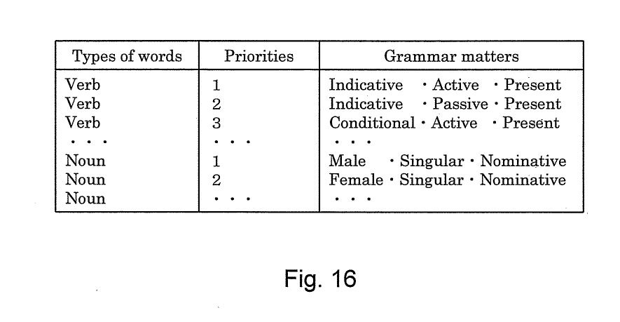

FIG. 16 shows priorities of the grammar matters in a word. If a verb that appears in the documents of the unknown language L0 represents “indicative mood, passive voice, present tense” in case of corresponding to the known language L1 and represents “indicative mood, active voice, present tense” in case of corresponding to the known language L2, the corresponding to the known language L2 is adopted.

In this embodiment, on the convenience of explanation, the priorities are not only based on languages but also categories of grammar. The apparatus 100 can set the priorities based on languages.

The following describes the case of one unknown language L0 and 3 or more known languages L1. That is document T0 of the unknown language L0 corresponding to document T1 of the known language L1, the document T2 of the known language L1, etc. The apparatus 100 can select the translation documents of language being the closest for L1 and adopt the above process as simple method. The apparatus 100 can use an analysis result of T0 created by the analysis result of T1, an analysis result of T0 created by the analysis result of T2, etc. by not considering the competition of languages.

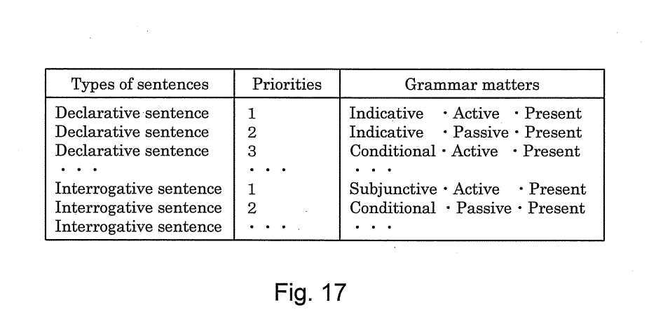

The method of resolving the competition of analysis results can be adopted based on the priorities of the analysis result of not only words but also sentences. FIG. 17 shows priorities of the grammar matters in a sentence. If a declarative sentence is analyzed based on L1 as “Indicative mood, Passive voice, Present tense” and based on L2 as “Indicative mood, Active voice, Present tense”, L2 is adopted.

Some methods of resolving the competition of the analysis results is described. The unit 106 uses one or more the methods.

(Step S804)

The unit 107 executes machine learning on the analysis result of the document of the unknown language L0 estimated by the unit 106, as supervisor data, and creates analyzer of the unknown language L0.

According to natural language processing apparatus of at least one embodiment described above, providing an analyzer of an unknown language by using the translation documents adapted by the designated languages and domains can create an analyzer suited to the document to be analyzed.

The apparatus creates supervisor data used as learning an analyzer based on the translation documents of an unknown language and a plurality of known language. An accuracy of the supervisor data becomes higher. The apparatus can create high-accurate analyzer.

The flow charts of the embodiments illustrate methods and systems according to the embodiments. It will be understood that each block of the flowchart illustrations, and combinations of blocks in the flowchart illustrations, can be implemented by computer program instructions. These computer program instructions can be loaded onto a computer or other programmable apparatus to produce a machine, such that the instructions which execute on the computer or other programmable apparatus create means for implementing the functions specified in the flowchart block or blocks. These computer program instructions can also be stored in a non-transitory computer-readable memory that can direct a computer or other programmable apparatus to function in a particular manner, such that the instruction stored in the non-transitory computer-readable memory produce an article of manufacture including instruction means which implement the function specified in the flowchart block or blocks. The computer program instructions can also be loaded onto a computer or other programmable apparatus/device to cause a series of operational steps/acts to be performed on the computer or other programmable apparatus to produce a computer programmable apparatus/device which provides steps/acts for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A natural language processing apparatus comprising:
a translation storage unit configured to store (a) a plurality of translation documents having an unknown language document and one or more known language documents, and (b) domains of the translation documents;
a translation search unit configured to specify one of the domains and search the translation storage unit for the translation documents;
a word extraction unit configured to extract a pair of words corresponding an unknown language word to a known language word, from the translation documents;
an answer creation unit configured to estimate an analysis result of the unknown language document in the translation documents based on the pair of words and an analysis result of the known language document in the translation documents; and
an analyzer creation unit configured to create an analyzer of the unknown language document based on the analysis result of the unknown language document.

2. The apparatus according to claim 1, wherein the answer creation unit estimates the analysis result of the unknown language document by using at least one of (a) a first degree of similarity representing similarity between a first domain specified by the translation search unit and a second domain of the searched translation document, and (b) a second degree of similarity representing similarity between the unknown language and the known language of the searched translation document.

3. The apparatus according to claim 2, wherein the answer creation unit estimates the analysis result of the unknown language word by using the analysis result of the known language word in case the second degree of similarity becomes higher than a predetermined threshold value, if an unknown language word is corresponding to a plurality of known languages words.

4. The apparatus according to claim 2, wherein the answer creation unit estimates the analysis result of the known language word by using the analysis result of the known language word in case the first degree of similarity becomes higher than another predetermined threshold value, if an unknown language word is corresponding to a plurality of known language words.

5. The apparatus according to claim 1, further comprising a domain estimation unit configured to estimate a domain of a document to be analyzed;
wherein the translation search unit is configured to search the translation storage unit for translation documents suiting to the domain estimated by the domain estimation unit.

6. The apparatus according to claim 1, further comprising
a language estimation unit configured to estimate a language of a document to be analyzed;
wherein the translation search unit is configured to search the translation storage unit for translation documents suiting to the language estimated by the language estimation unit.

7. A natural language processing method comprising:
accessing a translation storage unit configured to store (a) a plurality of translation documents having an unknown language document and one or more known language documents, and (b) domains of the translation documents;
specifying one of the domains and searching the translation storage unit for the translation documents;
extracting a pair of words corresponding an unknown language word to a known language word, from the translation documents;
estimating an analysis result of the unknown language document in the translation documents based on the pair of words and an analysis result of the known language document in the translation documents; and
creating an analyzer of the unknown language document based on the analysis result of the unknown language document.

8. A computer program product having a non-transitory computer readable medium including programmed instructions for performing a machine translation processing, wherein the instructions, when executed by a computer, cause the computer to perform:
accessing a translation storage unit configured to store (a) a plurality of translation documents having an unknown language document and one or more known language documents, and (b) domains of the translation documents;
specifying one of the domains and searching the translation storage unit for the translation documents;
extracting a pair of words corresponding an unknown language word to a known language word, from the translation documents;
estimating an analysis result of the unknown language document in the translation documents based on the pair of words and an analysis result of the known language document in the translation documents; and
creating an analyzer of the unknown language document based on the analysis result of the unknown language document.
